(19) United States
(12) Patent Application Publication
(10) Pub. No.: US 2013/0286640 A1
(43) Pub. Date: Oct. 31, 2013

(54) KNIVES HAVING A HANDLE ADAPTED FOR EASE OF GRASPING

(71) Applicant: Hakim Isler, Fayetteville, NC (US)

(72) Inventor: Hakim Isler, Fayetteville, NC (US)

(21) Appl. No.: 13/869,924

(22) Filed: Apr. 24, 2013

Related U.S. Application Data
(60) Provisional application No. 61/638,460, filed on Apr. 25, 2012.

(51) Int. Cl. B26B 1/10; F21V 21/00; F41H 9/10; F41A 9/61; B26B 3/06; B26B 1/02

(52) U.S. Cl. CPC B26B 1/10; B26B 3/06; B26B 1/02; F41H 9/10; F41A 9/61; F21L 15/08
USPC 362/191; 30/314; 30/151; 30/155; 222/470; 42/49.01

(57) ABSTRACT

A fixed-blade, folding, or switch blade knife having a handle, or a tool, wherein the handle includes a hook to enable the user to rapidly grasp and acquire the knife or tool.

### FIELD OF THE INVENTION

The present invention relates to knives, and in particular, to knives having a handle adapted for ease of grasping, for example, by including a hook at or near the end of the handle for hooking the users fingers as the knife is withdrawn from a sheath.

### BACKGROUND OF THE INVENTION

Knives come in a variety of shapes and sizes and are adapted for a multitude of uses. There are at least two main categories of knives: fixed-blade knives and folding knives. Fixed-blade knives do not have folding blades and are typically stronger and more stable than folding knives due to their fixed blade-handle construction. Fixed-blade knives are common among knives found in the kitchen and used for food preparation, such as to chop, mince, slice and dice foods. Folding knives, on the other hands, can pivot along the blade to fold into the handle. Unlike fixed-blade knives, folding knives do not have a fixed blade-handle construction and thus are not as strong or as stable as fixed-blade knives. Folding knives are commonly used as utility knives or weapons. An adaptation of a folding knife is a switch blade, which may include a spring mechanism to deploy or close the knife blade from the handle.

During times of high stress, such as combat or emergency situations, fine motor skills are hard to employ. Because of this loss of fine-motor skills, it frequently becomes difficult to acquire knives and other tools, such as flash-lights, batons and mace.

Thus, it would be desirable to have knives and other tools which include a mechanism for more easily acquiring them. The present invention provides such knives and other tools.

### SUMMARY

In one embodiment, the invention relates to knives or other tools that include a handle, wherein the handle includes a hook, lever, or other device (hereby referred to as a hook) that enables the knives or tools to be rapidly grasped, acquired, snagged, and/or retrieved by the user. The ability to be able to quickly grasp and acquire the knife or other tool, particularly during times of combat or other emergency situations, can mean the difference between life and death. Where gross motor skills are employed, a user can fumble for an ordinary knife or other tool, and fail to properly grasp and acquire it. However, because the hook is at or near the end of the handle, the user's hand is quickly guided to the proper position to grasp and acquire the knife or other tool, making it much easier to grasp and acquire the knife or other tool in emergency situations.

The hook, lever, and the like is designed to catch a portion of the users hand when slid over the surface of the knife handle or tool grip. This catch helps in the tools acquisition before a complete grip can be established.

The hook latches on to tools handle area in a perpendicular fashion. It can be straight or slightly curved near its point (forward or back). Its height can range between 0.25 inches to 1 inch, the radius of the curve in the hook can be anywhere from zero curvature inches to 1 inch of curvature. The thickness of the hook, lever, and the like typically ranges from 0.05 to 2inches in thickness, width, depth, and/or circumference.

The hook typically sits on the handle of the knife or tool (including tactical and non-tactical knives and tools), or is an integrated part of the handle. In one embodiment, the hook is permanently affixed to the handle of the knife or tool. In another embodiment, the hook is removably attached to the handle of the knife or tool.

In one embodiment, the hook is substantially perpendicular to the knife blade or tool. In this embodiment, as the user's hand comes into contact with the hook, and the knife or tool is withdrawn from its holder or sheath, the knife blade, or the tool, is in the right configuration for use. Where a blade has a single edge, versus a double edge, ideally the hook is located perpendicular to the knife blade, in such a way that when the user's hand contacts the knife handle and the hook, and the knife is withdrawn, the blade is on the same side of the handle as the hook.

In some embodiments, the hook can be rotated to the right or to the left, and/or can be placed in the middle, rear or on the side of the handle.

In the event that the handle is round, then the hook can be in the middle or rear along the circumference of the handle. In one embodiment, the hook is angled forward or backwards, i.e., not perpendicular to the handle, but at less than or greater than a ninety degree angle relative to the handle.

The hook can be attached to a knife or tool using any known methodology. Examples include a snap-in-place device, using screws that go through the device and attach the hook, welding the hook in place, attaching the hook via a slide-and-lock device, or by screwing the hook itself into the tool.

Where the knife is a fixed-blade knife or a switch blade knife, the location of the hook at or near the end of the handle allows the user to have the knife in the proper orientation for use as it is withdrawn from a sheath. However, in another embodiment, the knife is a tactical folding knife (also known as a tactical folder), which includes a clip. In use, the knife is typically placed in a pocket, or inside the waistline, of the pants the user is wearing. The clip is usually positioned on the outside of the pocket or waistline. In this embodiment, placing a hook at or near the top of the clip allows for rapid acquisition of the tactical folder, and allows the folder to be more easily withdrawn. From there, the knife is un-folded, and the hook can provide some protection for the user's fingers, for example, if the user is attacked by another person armed with a knife.

Other objects, features and advantages of the present invention will become apparent to those skilled in the art from the following detailed description.

### BRIEF DESCRIPTION OF THE DRAWINGS

FIG. 1 is a view of a knife handle including a hook, where the view is looking down from the top of the knife blade to the bottom of the knife handle.

FIG. 2 is a perspective view of a knife with a knife handle including a hook.

FIG. 3 is a side view of a knife with a knife handle including a hook.

FIG. 4 is a rear view of a knife handle including a hook perpendicular to the knife blade.

FIG. 5. is a top view of a knife handle including a hook.

FIG. 6 is a rear view of a knife handle including a hook.

FIG. 7 is a view of a knife handle including a hook, where the hook is removably attached to the knife handle with screws.

Like numerals refer to like parts throughout the several views of the drawings.

### DETAILED DESCRIPTION

Knives and other tools that include a hook that allows the user to rapidly grasp and acquire the knives or tools are disclosed. The present invention will be better understood with reference to the following detailed description.

Knives

Three different types of knives are intended to be within the scope of the invention, namely, fixed-blade knives, switch blade knives, and folding knives.

As used herein, fixed-blade knives are generally characterized as having a handle and a blade that is fixed together and do not fold together or are joined by a pivot or other moving joint. The fixed-blade knife comprises a knife body with a blade having at least one cutting edge, and an elongated handle extending from the blade. The fixed-blade knives disclosed herein use a handle that comprises, or is adapted to receive, a hook, which hook can be pivotally or slideably coupled to the knife body. In one aspect of this embodiment, the knife body may be formed as a single integral structure. Alternatively, the blade and the handle may comprise two separate structures, made of different material, which are immovably joined together. In one aspect of this embodiment, the knife is located in a sheath.

The fixed-blade knife comprises a blade having at least one cutting edge, and a handle having a first and second end. The first end of the handle is proximal to the blade and the second end of the handle is distal to the blade. The hook is typically connected to the second end of the handle. The handle can include, or be adapted to include, means for attaching the hook in a permanent or removable fashion. Examples include screw holes, clips, and the like.

As used herein, switch blade knives are generally characterized as having a handle with a top end and a bottom end, and a blade that is spring-loaded within the handle, such that when a switch is engaged, the spring is released, and the blade is extended. The blade can be extended straight from the top end of the knife handle, or around a pivot or other moving joint.

As used herein, folding knives are generally characterized as having a handle with a top end and a bottom end, and a blade that is oriented around a pivot or other moving joint, such that it can be opened when needed, and the blade stored within the handle when not in use. Folding knives typically also include some type of means for holding the blade in order to open the knife, such as a hole in the blade in which to place the user's thumb, or a ridge or other vertically-mounted object that can be pushed, typically by the user's thumb, to open the knife. Folding knives frequently include a clip or other means for attaching the knife to the user's apparel, located on the handle. In use, the folding knife is stored, typically with the clip, rather than the handle, being visible in the user's pants pocket, or waist band. This positions the knife in a way that it can be readily removed, and the blade brought to bear, in time of need.

The knives described herein can be any type of knife that is stored in a sheath, including tantos, boot knives, Bowie knives, diver's knives, hunting knives, machetes, multitool knives, pocket knives, straight razors, survival knives, which typically include a hollow handle filled with survival equipment, switchblade knives, ghurkas, dirks, daggers, push knives, and the like. The blade can be any size, from less than an inch, to more than fourteen inches, but typically, the blade ranges from two to eight inches in length.

The length of the knife handle can also vary, and is usually between around two and six inches in length). When the handle is on a folding knife, the handle is usually longer than the blade.

Sheaths for the knives can be present in various places on the user, including shoulder, chest, on body armor, on the thigh, on the ankle, inside a boot, inside a sleeve, on a forearm, on a bicep, in a belt, in a pocket, and the like.

In each of these embodiments, the knife can include a hook, but the position of the hook varies depending on the type of knife, as described in more detail below.

Tools

As used herein, a tool is intended to be something a user might use in an emergency situation, where having a hook to help grasp the tool is handy, particularly in an emergency situation. Representative tools include pepper spray/mace, flashlights, hatchets, cell phones, cameras, sirens, magazines for pistols and rifles, and the like.

Tools using the hook can be placed, for example, on the waist (on civilian and tactical belt or belt loop), thigh (thigh rig/thigh paddle for pistols and extra magazines), pockets, ankle, calf, chest (and body armor), and forearms.

Depending on the particular tool, the position of the hook will vary. For example, when using a can of pepper spray/mace, the spray button points either toward or away from the user. Frequently, in times of emergency, a user may not have time to ensure that the spray button is facing the attacker. By placing a hook on the top of the bottle, near the spray button, such that the top finger of the hand engaging the spray is in contact with the hook, the user can be sure that the spray button is facing the right direction. Of course, the position of the hook in such a case will depend on whether the user is right handed or left handed. To deal with this issue, spray cans with hooks near the spray buttons can be designed for both left and right handed users, or a removable hook can be used, and applied by the intended user to whichever side is most appropriate.

In the case of a flashlight, it may be optimal to place the hook opposite the on-off button for the flashlight, so that upon withdrawing the flashlight from a holder, such as a utility belt, the thumb will be in an optimal position to engage the on-off button.

In the case of a magazine, it is important to understand that magazines are often flush mounted in the pistol or rifle in which they are placed. If a hook is placed anywhere along the body of the magazine, it would cause the magazine to not be loaded properly. However, if the hook is placed at the end of the magazine (the end furtherest from where the bullets exit the magazine), the magazine can be placed inside the pistol or rifle and be fully engaged.

Hooks

For the purposes of this application, the term “hook” refers to all of the possible names that follow.
1. Dragon's Talon;
2. A.R. Hook (acquisition and retention hook)
3. A.R. Catch (acquisition and retention catch)
4. Knife hook
5. Knife catch
6. Acquisition hook
7. Retention hook

The hook latches onto a knife's or tool's handle area in a substantially perpendicular fashion. It can be straight or slightly curved near its point (forward or back). Its height typically ranges between 0.25 inches to 1 inch, and the radius of the curve in the hook can be anywhere from zero curvature inches to 1 inch of curvature over the length of the hook. The thickness, width, depth, and/or circumference of the hook typically ranges from about 0.05 to about 2 inches in any dimension.

The hook typically sits on the handle of the knife or tool (including tactical and non-tactical knives and tools), or is an integrated part of the handle. In one embodiment, the hook is permanently affixed to the handle of the knife or tool. In another embodiment, the hook is removably attached to the handle of the knife or tool.

In one embodiment, the hook is substantially perpendicular to the knife blade or tool. In this embodiment, as the user's hand comes into contact with the hook, and the knife or tool is withdrawn from its holder or sheath, the knife blade, or the tool, is in the right configuration for use. Where a blade has a single edge, versus a double edge, ideally the hook is located perpendicular to the knife blade, in such a way that when the user's hand contacts the knife handle and the hook, and the knife is withdrawn, the blade is on the same side of the handle as the hook.

In some embodiments, the hook can be rotated to the right or to the left, and/or can be placed in the middle, rear or on the side of the handle.

In the event that the handle is round, then the hook can be in the middle or rear along the circumference of the handle. In one embodiment, the hook is angled forward or backwards, i.e., not perpendicular to the handle, but at less than or greater than a ninety degree angle relative to the handle.

Tools using the hook can be placed, for example, on the waist (on civilian and tactical belt or belt loop), thigh (thigh rig/thigh paddle for pistols and extra magazines), pockets, ankle, calf, chest (and body armor), and forearms.

The hook can be attached to a knife or tool using any known methodology. Examples include a snap-in-place device, using screws that go through the device and attach the hook, welding the hook in place, attaching the hook via a slide-and-lock device, or by screwing the hook itself into the tool. Those of skill in the art can readily determine how to attach a hook to a knife handle, including, but not limited to, drilling holes to receive screws, and providing a hook with screw holes so that the two can be screwed together, attaching the hook to the knife handle with adhesives, such as epoxy adhesives, placing grooves on the sides of the knife handle, and using a hook with a mechanism that has a wider diameter than the grooves, which mechanism can be tightened, for example, by turning a screw, so that the diameter is decreased, and the mechanism becomes locked in the grooves, thereby attaching the hook to the knife handle.

Where the knife is a fixed-blade knife or a switch blade knife, the location of the hook at or near the end of the handle allows the user to have the knife in the proper orientation for use as it is withdrawn from a sheath. However, in another embodiment, the knife is a tactical folding knife (also known as a tactical folder), which includes a clip. In use, the knife is typically placed in a pocket, or inside the waistline, of the pants the user is wearing. The clip is usually positioned on the outside of the pocket or waistline. In this embodiment, placing a hook at or near the top of the clip allows for rapid acquisition of the tactical folder, and allows the folder to be more easily withdrawn. From there, the knife is un-folded, and the hook can provide some protection for the user's fingers, for example, if the user is attacked by another person armed with a knife.

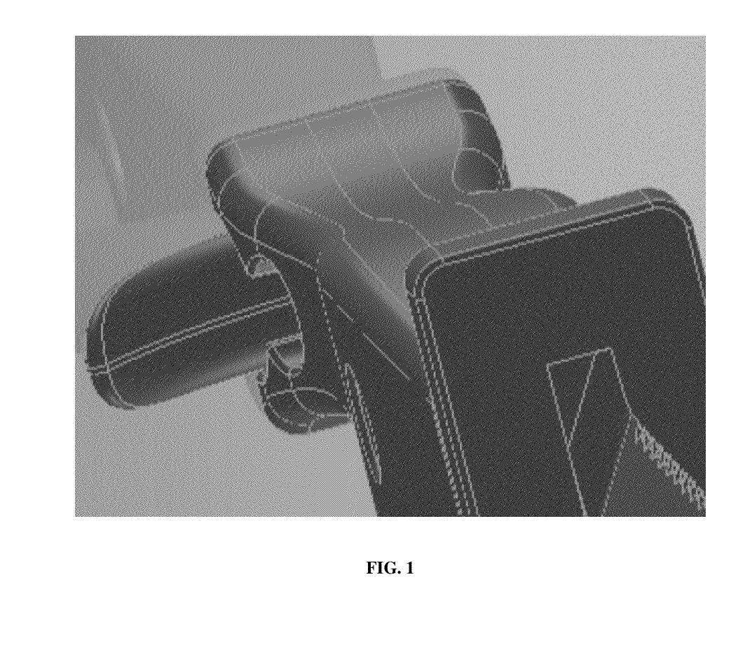

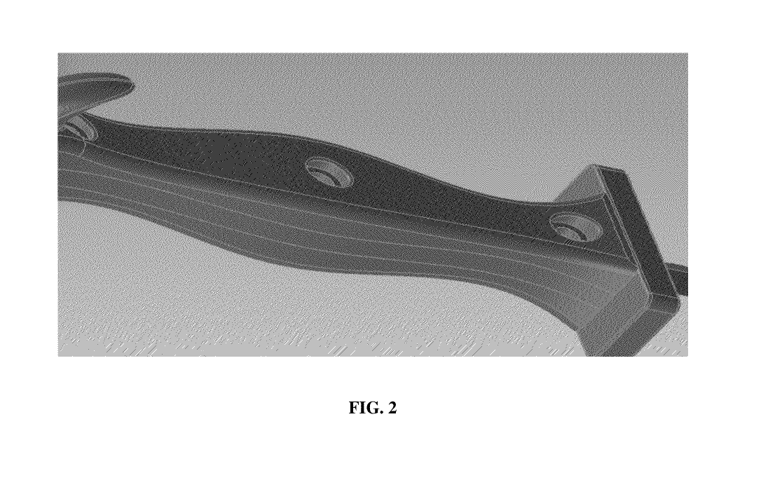

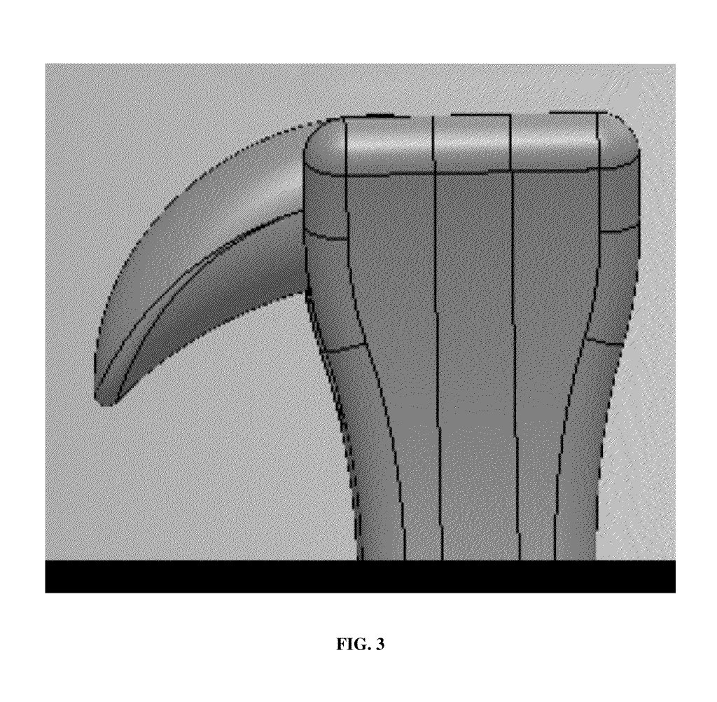

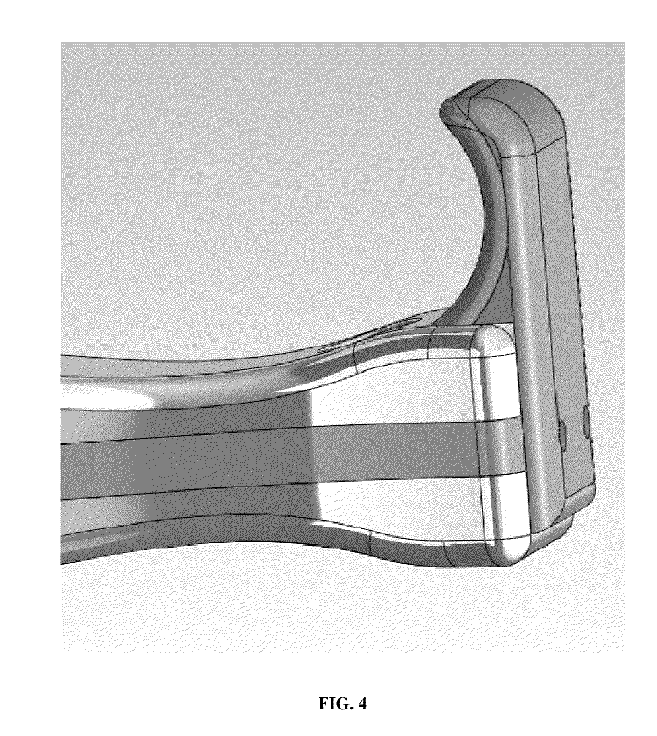

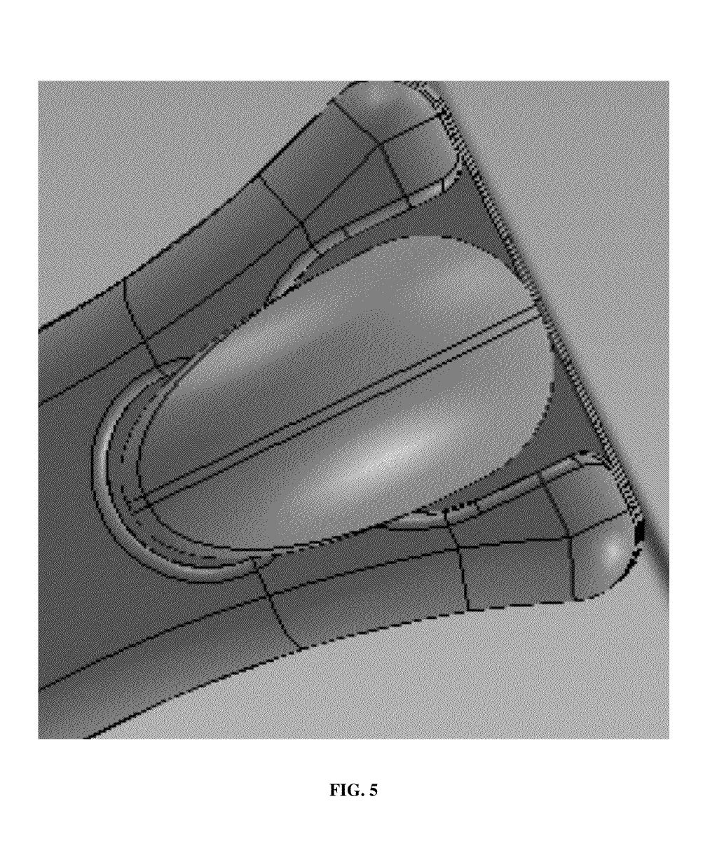

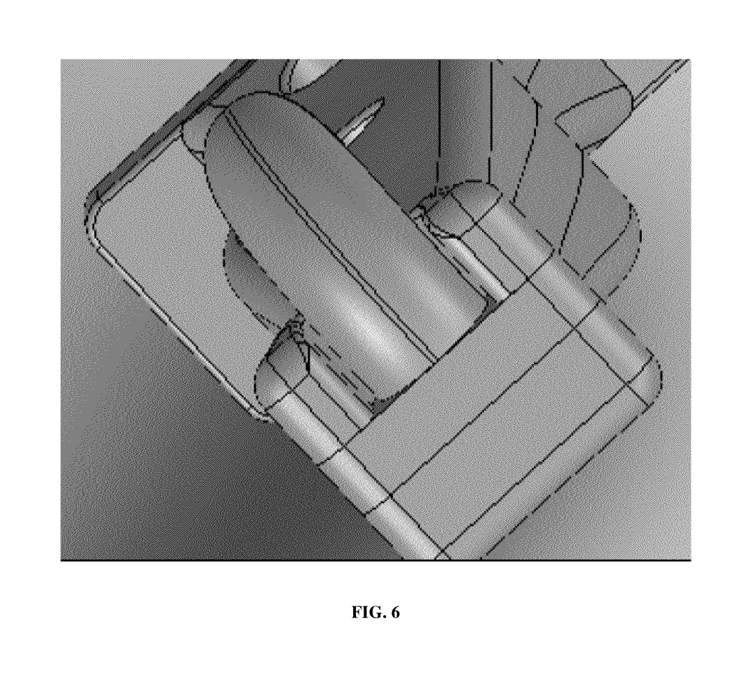

Turning now to the Figures, FIG. 1 depicts a fixed-blade knife that includes a hook on the handle. The view is looking down from the top of the knife blade to the bottom of the knife handle. FIG. 2 is a perspective view of a knife with a knife handle including a hook. FIG. 3 is a side view of a knife with a knife handle including a hook. FIG. 4 is a rear view of a knife handle including a hook perpendicular to the knife blade. FIG. 5 is a top view of a knife handle including a hook. FIG. 6 is a rear view of a knife handle including a hook. While the blade itself is not shown clearly, such is apparent to those of skill in the art. The novelty of the invention described herein is the use of a hook on the knife handle, enabling the user to quickly grasp and acquire the knife.

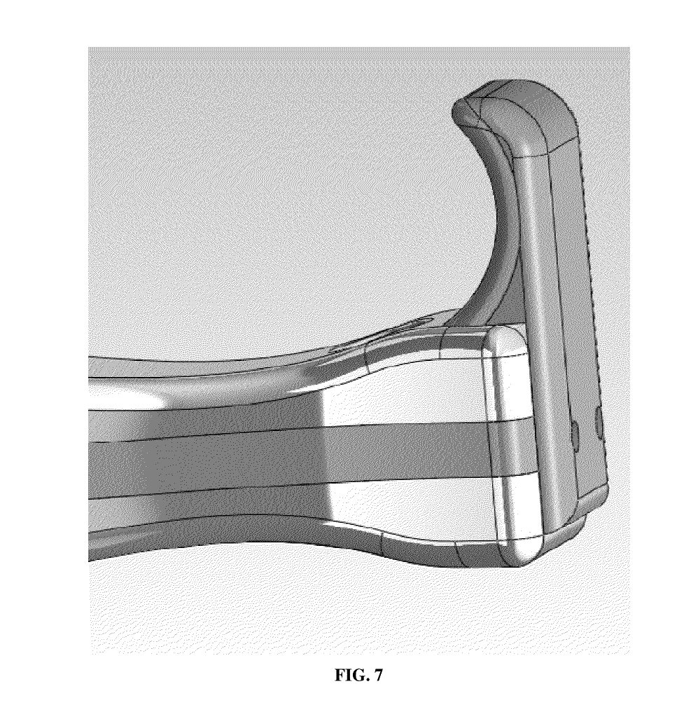

One aspect of the embodiment in which the hook is removably attached to the knife handle is shown in FIG. 7, which is a view of a knife handle including a hook, where the hook is removably attached to the knife handle with screws (two screw holes are shown, but more stability can be obtained, for example, by using three screws, such as three screws in a substantially triangular orientation).

Using the teachings described herein, one of skill in the art can attach a hook to virtually any knife or tool handle, and thus enable the knife or tool to be readily grasped and acquired in any emergency situation.

It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

What is claimed is:

1. A fixed-blade knife comprising:
a) a fixed blade knife body comprising a single knife blade having a cutting edge and an elongated handle extending from the knife blade, the elongated handle comprising a top end and a bottom end, where the top end is proximal to the knife blade, and the bottom end distal to the knife blade, and
b) a hook attached at or near the distal end of the knife handle, substantially perpendicular to the knife blade.

2. The fixed-blade knife of claim 1, wherein the knife is provided in a sheath.

3. The fixed-blade knife of claim 1, wherein the hook is permanently affixed to the knife handle.

4. The fixed-blade knife of claim 1, wherein the hook is releasably affixed to the knife handle.

5. The fixed-blade knife of claim 4, wherein the hook is releasably affixed to the knife handle using screws.

6. A folding knife comprising:
a) a knife body comprising a single blade having a cutting edge and an elongated handle, wherein the blade is pivotably mounted within the handle at a pivot point, wherein the elongated handle comprises a top end and a bottom end, where the top end is proximal to the pivot point, and the bottom end distal to the pivot point,
b) a clip with an open end and a closed end, wherein the closed end is affixed to the handle near the pivot point, such that the open end is near the bottom end of the handle, and can be clipped onto a user's apparel, and
c) a hook attached at or near the closed end of the clip, substantially perpendicular to the knife blade.

7. The folding knife of claim 6, wherein the hook is permanently affixed to the clip.

8. The folding knife of claim 6, wherein the hook is releasably affixed to the clip.

9. The folding knife of claim 8, wherein the hook is releasably affixed to the clip using screws.

10. A handgun or rifle magazine comprising a hook attached at or near the bottom of the magazine.

11. The magazine of claim 10, wherein the hook is permanently affixed to the magazine.

12. The magazine of claim 10, wherein the hook is releasably affixed to the magazine.

13. The magazine of claim 10, wherein the hook is releasably affixed to the magazine using screws.

14. Comprising a hook attached at or near the bottom of the magazine.

15. A spray can comprising mace or pepper spray, a spray button, and a hook attached near the spray button.

16. The spray can of claim 15, wherein the hook is permanently affixed to the can.

17. The spray can of claim 15, wherein the hook is releasably affixed to the can.

18. The magazine of claim 17, wherein the hook is releasably affixed to the can using screws.

19. A flashlight comprising an on-off switch or button, and a hook mounted onto the flashlight on the opposite side of the on-off switch or button, at approximately the same distance from the end of the flashlight as the on-off switch or button.

20. The flashlight of claim 19, wherein the hook is permanently affixed to the flashlight.

21. The flashlight of claim 19, wherein the hook is releasably affixed to the flashlight.

21. The flashlight of claim 19, wherein the hook is releasably affixed to the flashlight using screws.
